(19) United States
(12) Patent Application Publication
(10) Pub. No.: US 2022/0307940 A1
(43) Pub. Date: Sep. 29, 2022

(54) MEASUREMENT APPARATUS FOR SURFACE SHAPE OF HIGHLY REFLECTIVE MIRROR

(71) Applicant: MLOptic Corp, Redmond, WA (US)

(72) Inventor: Zhiping Song, Nanjing (CN)

(21) Appl. No.: 17/617,911

(22) PCT Filed: May 20, 2020
(86) PCT No.: PCT/CN2020/091352

§ 371 Date: Dec. 9, 2021

(30) Foreign Application Priority Data
Aug. 14, 2019 (CN) 201910751630.5

(51) Int. Cl. G01M 11/02; G01B 11/24; G01B 11/25

(52) U.S. Cl. CPC G01M 11/025; G01B 11/2441; G01B 11/254; G02B 27/14

(57) ABSTRACT

A measurement apparatus for a surface shape of a highly reflective mirror, comprising a light source, a beam splitting sheet, a collimator, a standard mirror plated with the beam splitter sheet, and a CCD imaging system. A light beam emitted by the light source passes through the beam splitting sheet, and is converted by the collimator into parallel light lo which passes through the standard mirror, a part of the light is reflected and returned by the standard mirror, and the other part of light passes through the standard mirror, and then reaches the surface of a measured mirror and is reflected back by the surface; the light IR reflected back by the standard mirror and the light It reflected back by the surface, pass through the standard mirror, forming interfering light that is returned to and reflected by the beam splitting sheet before entering the CCD imaging system.

### PRIORITY CLAIM AND RELATED APPLICATIONS

This national stage application claims the benefit of priority from PCT/CN2020/091352 filed on Aug. 14, 2019. Said application is incorporated by reference in its entirety.

### BACKGROUND OF THE INVENTION

### 1. The Field of the Invention

The invention relates to imaging measurement and more specifically to a high-reflectivity mirror surface shape measuring device.

### 2. Background Art

The problem encountered when measuring the shape of a high-reflective mirror with an ordinary flat standard mirror includes the following: When the incident light lo returns through the standard surface of the standard mirror, the reflected light IR is only 4% of the incident light lo, and the reflected light is reflected by the standard mirror through the measured mirror surface. The light It is 18˜92% of the incident light lo, so the intensity difference between the two reflected lights is too large It≥5IR, which results in very unclear interference fringes (as shown in FIG. 4) and cannot be fully analyzed. The result of this analysis is very inaccurate. To solve this problem, the current solution adopted in the market is: adding a filter in front of the standard lens. Although this method can clearly reflect the interference fringes, the entire interference surface will have filter lines (as shown in FIG. 5). In this way, the actual surface shape accuracy of the tested lens is affected by the filter.

### SUMMARY OF THE INVENTION

Disclosed herein is a highly reflective mirror-shaped measuring device, and the very clear interference pattern fringes obtained by using the measuring device. In order to solve the above technical problems, the technical solutions adopted by the present invention are as follows: In accordance with the present invention, there is provided a measuring device for the surface shape of a highly reflective mirror, including a light source, a beam splitter, a collimator, a standard mirror and a CCD imaging system, the front surface of the standard mirror is plated with a beam splitter; the light beam emitted by the light source passes through the beam splitter, and the collimator irradiates the incident light on the standard mirror. When the incident light lo passes through the standard mirror, a part of the light is reflected back by the standard mirror coated with a spectroscopic film to yield the standard reflected light IR, and the other part of light passes through the standard mirror and then reaches the surface of the measured mirror, and is reflected back by the surface of the measured mirror and then passes through the standard mirror to yield the measured reflected light ray It and the standard reflected light ray IR. The standard reflected light IR and the measured reflected light It form interference light and that is returned to the beam splitter and reflected by the beam splitter to enter the CCD imaging system, and the intensity ratio of the two coherent lights It/IR is 0.2-1, wherein, the angle between the beam splitter and the horizontal plane is 45°. The thickness of the spectroscopic film is 10-20 nm, the change of the surface shape of the standard mirror after coating is very small, and the coated surface can withstand repeated cleaning and wiping, wherein the collimator converts the point light source emitted by the light source into parallel light to irradiate on the standard mirror. The working principle of the measuring device of the present invention: the light beam emitted from the light source passes through the beam splitter, the light lo is converted into parallel light by the point light source through the collimator, a part of the light is reflected back by the standard mirror (reflected light intensity IR), and the other part of the light passes through the standard mirror and reaches the surface of the mirror under test, and is reflected back by the surface of the measured mirror and then passes through the standard mirror to yield the measured reflected light ray It and the standard reflected light ray IR. The two rays of IR and It form interference rays and return to the beam splitter. Due to the angle of the beam splitter, all the interfering rays are refracted, and the interference fringes of the two rays of light are observed through the CCD imaging system. When the intensity ratio of the two coherent lights It/IR is 0.2˜1, the obtained interference pattern fringes are very clear. For the parts under test having mirror reflectivity between 60% and 100%, the spectroscopic film prepared by the vacuum coating process on a standard mirror requires that the reflectivity of the spectroscopic film on the glass side to be 25% lo (IR is 25% lo), the reflectivity of the spectroscopic film on the air side to be zero, and the transmissivity of the spectroscopic film to be 50% lo and the absorptivity of the spectroscopic film to be 25% lo. The measured light is reflected by the measured mirror after passing through the standard mirror, and the light reflected by the measured mirror reaches the standard mirror without reflection, and completely passes through the spectroscopic film of the standard mirror, at this moment, It is (50%*(60%˜100%)−25%) lo, that is, It=5%˜25% lo. Therefore, for different mirrors under test, due to their different surface reflectivity, in order to meet the intensity ratio of the two coherent lights It/IR of 0.2˜1, the reflectivity, transmissivity and absorptivity of the corresponding spectroscopic film on the standard mirror are all different.

### BRIEF DESCRIPTION OF THE DRAWINGS

FIG. 1 is a schematic diagram of the structure of a measuring device for a highly reflective mirror surface according to the present invention.

FIG. 2 is a schematic diagram of a measuring device for a highly reflective mirror surface according to the present invention.

FIG. 3 is a graph of interference fringes obtained using the measuring device of the highly reflective mirror surface of the present invention.

FIG. 4 is a graph of interference fringes obtained by measuring the shape of a highly reflective mirror in the prior art.

FIG. 5 shows the interference fringe pattern obtained by adding a filter to the front of the standard lens to measure the shape of a highly reflective mirror.

### PARTS LIST

1—measured mirror or mirror under test
2—standard mirror
3—collimator
4—CCD imaging system
5—beam splitter
6—light source
7—beam splitting film or beam splitting sheet

### Particular Advantages of the Invention

The high-reflection mirror shape measuring device of the present invention effectively reduces the intensity difference of the two reflected lights by coating the standard mirror, so that the obtained interference pattern fringes are very clear, and the measured surface of the high-reflection mirror surface shape is very clear.

### DETAILED DESCRIPTION OF A PREFERRED EMBODIMENT

The invention will be better understood from the following examples, however, it will be readily understood by those skilled in the art that the description of the examples is intended to illustrate the invention only and should not be construed as limiting the invention as described in detail in the claims.

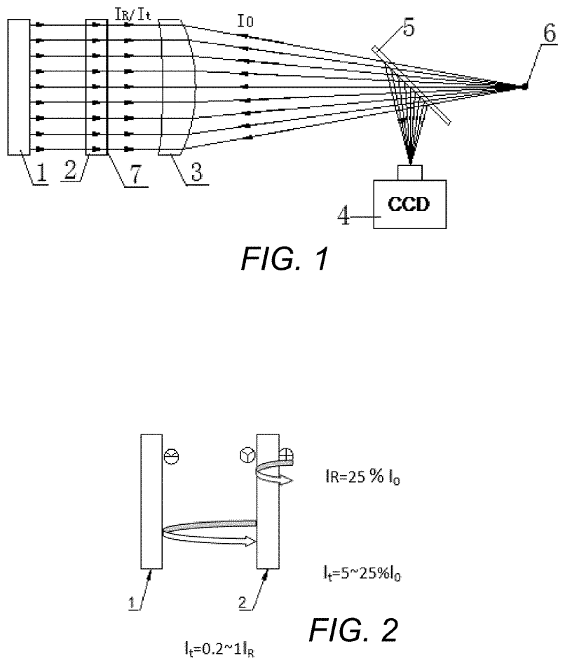

As shown in FIG. 1, the high-reflectance mirror surface shape measuring device includes a light source 6, a beam splitter 5, a collimator 3, a standard mirror 2 and a CCD imaging system 4. The front surface of the standard mirror 2 is plated with a spectroscopic film 7. The light beam emitted by the light source 6 passes through the beam splitter 5 and then is converted into parallel light by the collimator 3, and when the parallel incident light lo passes through the standard mirror 2, a part of the light is reflected back by the standard mirror 2 plated with the beam splitting film 7 (shown as IR). Another part of the light reaches the surface of the tested mirror 1 after passing through the standard mirror 2, and is reflected by the surface of the tested mirror 1. The light It passing through the standard mirror 2 forms interference light back to the beam splitter 5, and enters the CCD imaging system 4 after being reflected by the beam splitter 5. The light intensity of the two coherent lights is adjusted by the beam splitter 7, and the intensity ratio It/IR is 0.2˜1. The angle between the beam splitter 5 and the horizontal plane is 45°.

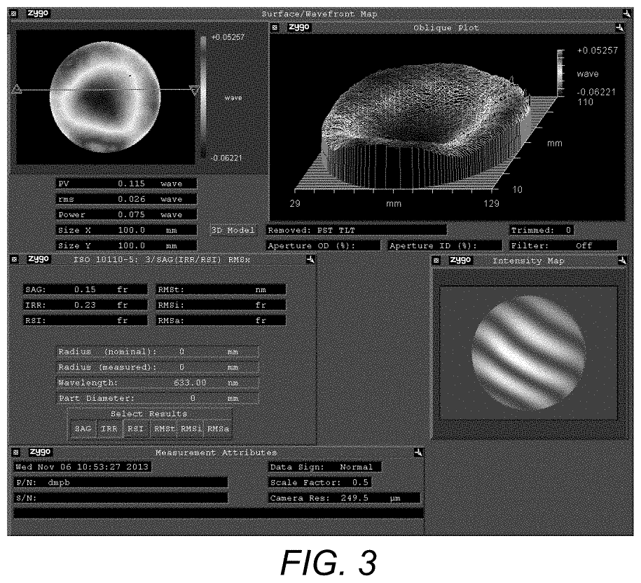

The reflectivity of the spectroscopic film 7 on the glass side is different from the reflectivity of the spectroscopic film 7 on the air side. In the embodiment of the present invention, the reflectivity of the measured reflector 1 is between 60% and 100%. The prepared spectroscopic film 7 has a reflectivity of 25% lo on the glass side, and the reflectivity of the spectroscopic film 7 on the air side is close to zero reflection (full transmission). The measuring light is reflected by the measured mirror 1 after passing through the standard mirror 2. The reflected light does not reflect after reaching the standard mirror 2, and completely passes through the spectroscopic film 7 of the standard mirror 2. The transmissivity of the spectroscopic film 7 is 50%, and the absorption rate of the spectroscopic film is 25% lo, as shown in FIG. 2. IR is 25% lo, and It is 5%-25% lo, so the intensity ratio of the two coherent lights It/IR is 0.2-1. When a beam of light passes through the standard mirror 2, the standard mirror 2 coated with the spectroscopic film 7 divides the incident beam into two paths. One light is reflected back by the standard mirror 2, that is, IR. This beam of light (IR) forms the standard wavefront for measurement. Another path of the light passes through the standard mirror 2 and reaches the measured reflector surface 1. After being reflected by the measured reflector surface 1, it passes through the standard mirror 2. This beam of light (It) forms the measurement wavefront, and the measurement wavefront contains the measured part. After the standard wavefront and the measured wavefront meet, interference fringes are formed by coherence. When the intensity ratio of the two coherent lights is 0.2˜1 times the relationship of It/IR, the interference pattern fringes obtained at this time are very clear, as shown in FIG. 3.

For different mirrors under test, due to their different surface reflectivity, in order to satisfy the intensity ratio of the two coherent lights It/IR of 0.2 to 1, the reflectivity, transmissivity and absorptivity of the corresponding spectroscopic film on the standard mirror 2 are all different. For the parts under test having mirror reflectivity between 60% and 100%, the spectroscopic film prepared by the vacuum coating process on a standard mirror requires that the reflectivity of the spectroscopic film on the glass side to be 25% lo (IR is 25% lo), the reflectivity of the spectroscopic film on the air side to be zero, and the transmissivity of the spectroscopic film to be 50% lo and the absorptivity of the spectroscopic film to be 25% lo. After passing through the standard mirror, the measuring light is reflected by the mirror under test and reflected by the mirror under test. The returned light reaches the standard mirror without reflection, and completely passes through the spectroscopic film of the standard mirror. At this time, It is (50%*(60%-100%)−25%) lo, that is, It=5%-25% lo, that is the light intensity It after the incident light is reflected by the measured reflector 1 through the spectroscopic film 7 is 5% to 25% of the incident light lo. The intensity of the two coherent lights satisfies the relationship of 0.2 to 1 for the ratio It/IR and very clear interference pattern fringes can be obtained.

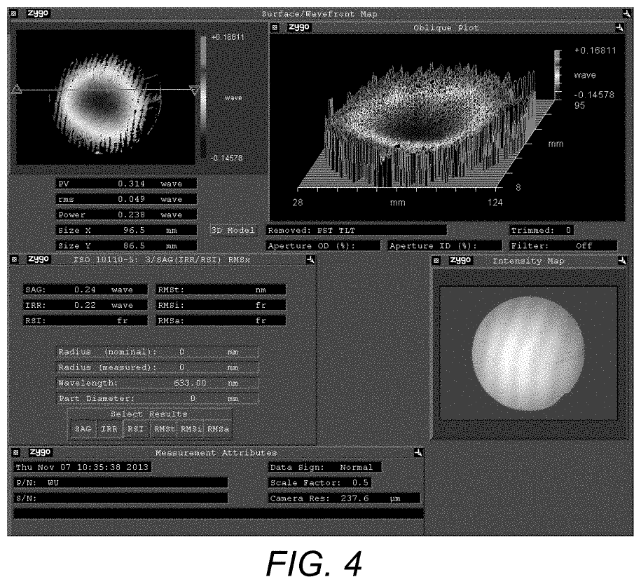

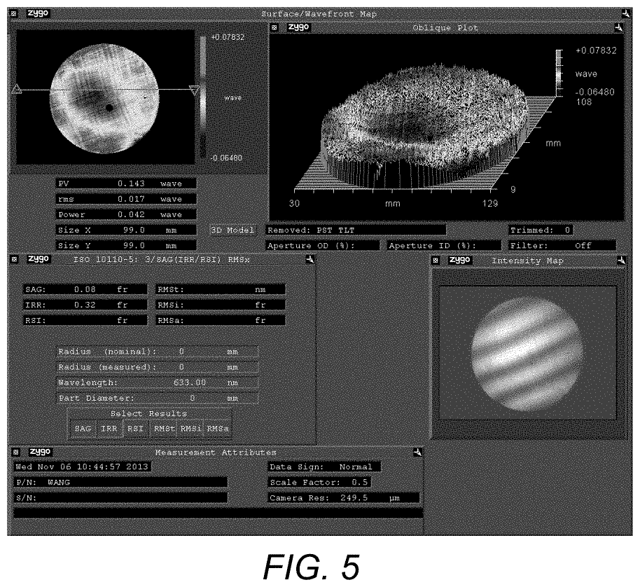

It can be seen from FIGS. 3 to 5 that the surface shape of the high-reflective mirror measured by the present invention after coating the standard mirror, is clearer, and at the same time, the grid interference measured by the filter screen is avoided, thereby improving the measurement accuracy.

The spectroscopic film of the present invention can be used on the surface of plane and spherical surfaces and other various standard mirrors. A standard mirror coated with a spectroscopic film can be used in measuring the mirrors of silver high-reflection film, aluminum high-reflection film and dielectric high-reflection film, silicon wafers, germanium slices, zinc selenide, zinc sulfide, metal slices and the surface shape of the pyramid and the surface shape of optical devices.

What is claimed herein is:

1. A measuring device for the surface shape of a highly reflective mirror, said device comprises a light source, a beam splitter, a collimator, a standard mirror, and a CCD imaging system, a front surface of said standard mirror is plated with a spectroscopic film, said collimator irradiates incident light lo of said light source on said standard mirror, a first part of the light is reflected and returned by the standard mirror coated with a spectroscopic film to yield a reflected light IR and a second part of the light reaches a mirror under test after passing through said standard mirror and is reflected from the surface of the mirror under test before passing through said standard mirror to yield a reflected light It, the reflected light IR and the reflected light It form an interference light which returns to said beam splitter before being directed into the CCD imaging system by the beam splitter, wherein the intensity ratio It/IR is 0.2˜1.

2. The measuring device of claim 1, wherein the angle between said beam splitter and the horizontal plane is 45°.

3. The measuring device of claim 1, wherein when the reflectivity of the mirror under test is between 60% and 100%, the reflectivity of the spectroscopic film on the glass side is 25% lo, the reflectivity of the spectroscopic film on the air side is zero, and the transmissivity of said spectroscopic film is 50% lo.

4. The measuring device of claim 1, wherein the thickness of said spectroscopic film is 10-20 nm.

5. The measuring device of claim 1, wherein said collimator converts the point light source emitted by said light source into parallel light to irradiate on said standard mirror.
